(19) United States
(12) Patent Application Publication
(10) Pub. No.: US 2026/0241474 A1
(43) Pub. Date: Aug. 20, 2026

(54) WELDING PROCESS, CONTAINER, AND METHOD FOR MANUFACTURING CONTAINER

(71) Applicants: TOYO ENGINEERING CORPORATION, Chiba-shi (JP); IHI Plant Services Corporation, Tokyo (JP)

(72) Inventors: Hiroyuki DOI, Chiba-shi (JP); Hisatoshi WATANABE, Chiba-shi (JP); Eiki NAGASHIMA, Chiba-shi (JP); Masashi TAKAHASHI, Chiba-shi (JP); Keisuke KIDA, Tokyo (JP); Kazuyoshi NISHIZAWA, Tokyo (JP); Kouji KUDOU, Tokyo (JP)

(73) Assignees: TOYO ENGINEERING CORPORATION, Chiba-shi (JP); IHI Plant Services Corporation, Tokyo (JP)

(21) Appl. No.: 19/318,829

(22) Filed: Sep. 4, 2025

(30) Foreign Application Priority Data
Feb. 20, 2025 (JP) 2025-025786

(51) Int. Cl. B23K 9/00; B23K 9/18; B23K 9/23; B23K 101/12; B23K 103/04

(52) U.S. Cl. CPC B23K 9/0026; B23K 9/18; B23K 9/23; B23K 2101/12; B23K 2103/04

(57) ABSTRACT

A welding process is related to a steel material of a container for liquid ammonia. The process includes forming a welded metal portion at a side of the steel material. The side is configured to be in contact with the liquid ammonia. In the forming the welded metal portion, a heat-affected zone is formed in the steel material at a position adjacent to the welded metal portion. The steel material is made of carbon steel or low-alloy steel. The welded metal portion is formed so that a Vickers hardness of the heat-affected zone becomes 280 HV or less.

### CROSS-REFERENCE TO RELATED APPLICATIONS

This application is based upon and claims the benefit of priority from Japanese Patent Application No. 2025-025786, filed on Feb. 20, 2025, the entire contents of which are incorporated herein by reference.

### BACKGROUND

### 1. Field

The following disclosure relates to a welding process of a steel material configured to be in contact with liquid ammonia, a container for liquid ammonia, and a method for manufacturing the container.

### 2. Description of Related Art

Ammonia has been widely used in various applications, such as refrigerants, a raw material for fertilizers, or the like. In recent years, ammonia is attracting attention as a next-generation energy source that reduces carbon dioxide emissions. In order to supply a vast amount of ammonia for these applications, there is a need for construction of large-sized ammonia tanks for storage or transportation of ammonia.

Liquid ammonia is corrosive to steel. Therefore, liquid ammonia may cause stress corrosion cracking (SCC) of steel. In order to restrict such SCC, a steel material having a relatively low mechanical strength, such as carbon steel, has been studied as a material configured to be used in a liquid ammonia environment, for example, an ammonia tank (e.g., refer to JP7160213B2).

When a steel material is welded, the hardness of the steel material increases in a heat-affected zone (HAZ) adjacent to the welded location. Accordingly, even if the steel material has a relatively low mechanical strength in a raw material state, stress corrosion cracking may occur in the heat-affected zone.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a welding process related to a steel material of a container for liquid ammonia is provided. The process includes forming a welded metal portion at a side of the steel material. The side is configured to be in contact with the liquid ammonia. In the forming the welded metal portion, a heat-affected zone is formed in the steel material at a position adjacent to the welded metal portion. The steel material is made of carbon steel or low-alloy steel. The welded metal portion is formed so that a Vickers hardness of the heat-affected zone becomes 280 HV or less.

In another general aspect, a container for liquid ammonia is provided. The container includes a steel material made of carbon steel or low-alloy steel, and a welded metal portion located on a side of the steel material. The side is configured to be in contact with the liquid ammonia. The steel material includes a heat-affected zone formed at a position adjacent to the welded metal portion. The heat-affected zone has a Vickers hardness of 280 HV or less.

In another general aspect, a method for manufacturing a container for liquid ammonia is provided. The method includes forming a welded metal portion at a side of a steel material of the container. The side is configured to be in contact with the liquid ammonia. The steel material is made of carbon steel or low-alloy steel. In the forming the welded metal portion, a heat-affected zone is formed in the steel material at a position adjacent to the welded metal portion. The welded metal portion is formed so that a Vickers hardness of the heat-affected zone becomes 280 HV or less.

Other features and aspects will be apparent from the following detailed description, the drawings, and the claims.

### BRIEF DESCRIPTION OF THE DRAWINGS

FIG. 1 is a cross-sectional view of a welded joint of a container.

FIG. 2 is a graph illustrating results of stress corrosion cracking tests when 1% strain was applied to samples.

FIG. 3 is a graph illustrating results of stress corrosion cracking tests when 5% strain was applied to samples.

FIG. 4 is a cross-sectional view of a welded joint illustrating first and second embodiments of a welding process.

FIG. 5 is a cross-sectional view of a welded joint illustrating a third embodiment of the welding process.

FIG. 6 is a partially enlarged view of FIG. 5.

FIG. 7 is a schematic diagram showing the shape of a steel material used in experimental examples.

FIG. 8 is a schematic diagram showing the positions of passes in a first welding of Experimental Example 1.

FIG. 9 is a schematic diagram showing the positions of passes in a second welding of Experimental Example 1.

FIG. 10 is a table showing a preheat temperature and a heat input of each pass of Experimental Example 1.

FIG. 11 is a graph illustrating Vickers hardness in the welded joint of Experimental Example 1 at a side where the first welding was performed.

FIG. 12 is a graph illustrating Vickers hardness in the welded joint of Experimental Example 1 at a side where the second welding was performed.

FIG. 13 is a schematic diagram showing the positions of passes in the first welding of Experimental Example 2.

FIG. 14 is a schematic diagram showing the positions of passes in the second welding of Experimental Example 2.

FIG. 15 is a table showing the preheat temperature and the heat input of each pass of Experimental Example 2.

FIG. 16 is a graph illustrating Vickers hardness in the welded joint of Experimental Example 2 at a side where the first welding was performed.

FIG. 17 is a graph illustrating Vickers hardness in the welded joint of Experimental Example 2 at a side where the second welding was performed.

FIG. 18 is a schematic diagram showing the positions of passes in the first welding of Experimental Example 3.

FIG. 19 is a schematic diagram showing the positions of passes in the second welding of Experimental Example 3.

FIG. 20 is a table showing the preheat temperature and the heat input of each pass of Experimental Example 3.

FIG. 21 is a graph illustrating Vickers hardness in the welded joint of Experimental Example 3 at a side where the first welding was performed.

FIG. 22 is a graph illustrating Vickers hardness in the welded joint of Experimental Example 3 at a side where the second welding was performed.

FIG. 23 is a schematic diagram showing the positions of passes in the second welding of Experimental Example 4.

FIG. 24 is a table showing the preheat temperature and the heat input of each pass of Experimental Example 4.

FIG. 25 is a graph illustrating Vickers hardness in the welded joint of Experimental Example 4.

FIG. 26 is a table showing results of experimental examples.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

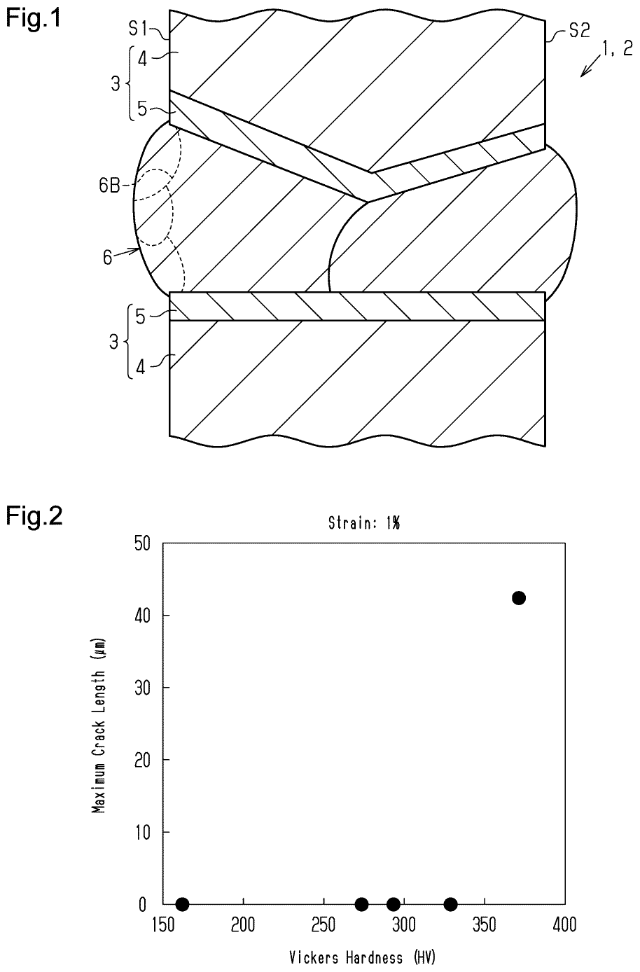

An embodiment of a welding process, a container, and a method for manufacturing a container will now be described with reference to FIGS. 1 to 6. After an embodiment of a container is described, first to third embodiments of a welding process will follow. The welding process is employed as part of a method for manufacturing the container.

### Container 1

A container 1 is an ammonia tank configured to hold liquid ammonia. The ammonia tank is a structure (e.g., vessel or the like) used to store or transport liquid ammonia. In an example, the container 1 is an on-ground low-temperature ammonia tank having a cylindrical shape. The container 1 may hold, for example, 10,000 tons or more of liquid ammonia.

The container 1 includes a welded joint 2 that is part of a side plate of the container 1. The welded joint 2 is a butt joint. The welded joint 2 includes a first surface S1 facing the inside of the container 1, and a second surface S2 facing the outside of the container 1. The first surface S1 is an inner surface of the container 1. The first surface S1 is configured to be in contact with liquid ammonia held in the container 1.

The welded joint 2 includes two pieces of the steel material 3 arranged in the vertical direction, and a welded metal portion 6 connecting the two pieces of the steel material 3. The welded metal portion 6 of the welded joint 2 is formed by performing horizontal welding on two pieces of the steel material 3 arranged in the vertical direction. That is, in FIG. 1, the welding direction is orthogonal to the plane of the drawing. The two pieces of the steel material 3 may form any type of groove, such as a single bevel groove, a double bevel groove (K-shaped groove), or the like.

The steel material 3 is made of carbon steel or low-alloy steel. Carbon steel is an alloy of iron and carbon. For example, carbon steel contains carbon in a range of approximately 0.02 mass % to approximately 2 mass %. Carbon steel may contain a small amount of silicon, manganese, phosphorus, or sulfur. Low-alloy steel is a steel material containing less than or equal to 5 mass % of an alloy element. Examples of an alloy element include chromium, niobium, vanadium, copper, phosphorus, and the like. In order to restrict stress corrosion cracking of the steel material 3 resulting from being in contact with liquid ammonia, an upper limit may be set on a physical property value of its mechanical strength, such as the tensile strength or the yield strength. In an example, the raw material of the steel material 3 may be carbon steel or low-alloy steel having a lower limit of 550 MPa or less on its tensile strength in accordance with Japanese Industrial Standards (JIS) Z 2241:2023. For example, the steel material 3 may be carbon steel or low-alloy steel having a tensile strength in a range of 485 MPa to 690 MPa, inclusive, in accordance with JIS Z 2241:2023. Further, the steel material 3 may be carbon steel or low-alloy steel having a sufficient toughness, so that the steel material 3 is unlikely to show low-temperature brittleness at a temperature of liquid ammonia (−34° C.).

In an example, the raw material of the steel material 3 may be ASTM A516Gr70N obtained by normalizing carbon steel that is in accordance with American Society for Testing and Materials (ASTM) A516Gr70. For example, the steel material 3 has a plate thickness of 8.0 mm or greater and 42.0 mm or less. The raw material of the steel material 3 may be, for example, ASTM A516Gr55, ASTM A516Gr60, or the like. Alternatively, the raw material of the steel material 3 may be ASTM A537 Class 1.

In the welded joint 2, the steel material 3 includes a base metal 4 and a heat-affected zone 5. The base metal 4 is a portion of the steel material 3 that was not affected by the heat of welding. In other words, the heat of welding had only a negligible effect on the base metal 4. That is, in the base metal 4, the characteristics of the steel material 3 in a raw material state remain the same even after welding. Although the characteristics of the steel material 3 in the heat-affected zone 5 have been changed by the heat of welding, the heat-affected zone 5 is a portion of the steel material that was not melted by the welding. The heat-affected zone 5 is formed in the steel material 3 at a position adjacent to the welded metal portion 6.

The welded metal portion 6 is formed by arc welding that fuses the steel material 3 and a material of a welding electrode. The material of the welding electrode may be determined in accordance with the carbon steel of the steel material 3. The welded metal portion 6 includes multiple beads 6B each formed by a welding pass. In FIG. 1, the broken lines schematically show some of the beads 6B in the welded metal portion 6.

The welded joint 2 is welded by, for example, submerged arc welding (SAW) or a combination of submerged arc welding and shielded metal arc welding (SMAW). The welded metal portion 6 may be formed in the following manner. First, multiple passes are performed at the side of one of the first surface S1 and the second surface S2. Next, gouging or the like may be performed. Then, multiple passes are performed at the side of the other of the first surface S1 and the second surface S2.

### Relationship of Hardness and Stress Corrosion Cracking

The relationship of hardness and stress corrosion cracking of the steel material 3 was verified by conducting stress corrosion cracking tests on samples of the steel material 3. The stress corrosion cracking tests will be described below.

The material (ASTM A516Gr70N) obtained by normalizing carbon steel in accordance with ASTM A516Gr70 was used for the samples of the steel material 3. Five samples having different levels of Vickers hardness in accordance with JIS Z 2244-1:2024 were prepared by changing conditions of rolling and heat treatment during the manufacture of the steel material 3. The five levels of hardness were, namely, 160 HV, 273 HV, 293 HV, 330 HV, and 370 HV. The Vickers hardness test force was 9.807 N. The level of 160 HV corresponds to the hardness of the base metal 4 in the steel material 3 of the welded joint 2. Further, the levels greater than or equal to 273 HV simulated the heat-affected zone 5 in the steel material 3 of the welded joint 2, in which the hardness has been increased by the heat of welding.

In the stress corrosion cracking tests, these samples were brought into contact with liquid ammonia. The stress corrosion cracking tests were conducted under conditions in which the temperature was −20° C. (−4° F.), and the pressure was the sum of ammonia vapor pressure and air partial pressure. Additives were added to the test system. The additives include 1 mass % of NH₄CO₂NH₂, 2 mass % of NH₄NO₃, 0.5 mass % of water (H₂O), and air containing 100 ppm of oxygen relative to the mass of liquid ammonia. The holding potential was set to +0.5 V with reference to a platinum reference electrode. The testing period was seven days. The levels of strain applied to the samples were 1% and 5%. The 1% strain is a condition that simulated a normal use environment of a low-temperature ammonia tank. The 5% strain is a condition that simulated a harsher use environment of the low-temperature ammonia tank.

FIG. 2 shows the maximum crack lengths observed after the tests, in which 1% strain was applied to the above-described samples having five different levels of Vickers hardness. As shown in FIG. 2, no cracks were observed in the samples having the four levels of Vickers hardness, namely, 160 HV, 273 HV, 293 HV, and 330 HV. On the other hand, a crack of approximately 40 μm was observed in the sample having the Vickers hardness level of 370 HV. These results indicate that under the condition of 1% strain, which corresponds to a normal use environment, stress corrosion cracking of the steel material 3 resulting from being in contact with liquid ammonia may be restricted when the Vickers hardness of the steel material 3 is less than 370 HV, preferably, less than or equal to 330 HV.

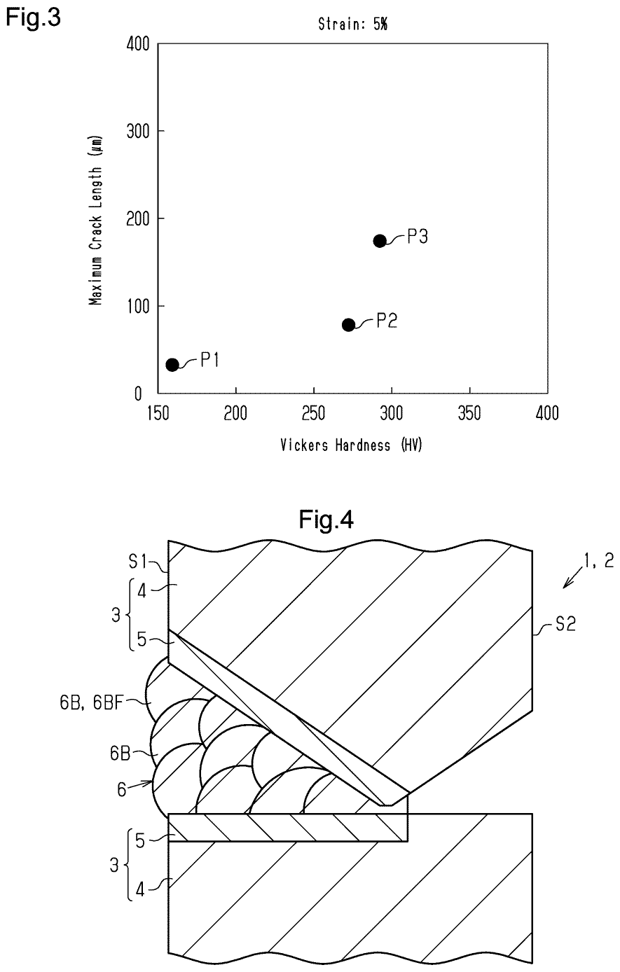

FIG. 3 shows the maximum crack lengths observed after the tests, in which 5% strain was applied to three of the above-described samples having Vickers hardness levels of 160 HV, 273 HV, and 293 HV. In FIG. 3, point P1 indicates the sample having a hardness of 160 HV, point P2 indicates the sample having a hardness of 273 HV, and point P3 indicates the sample having a hardness of 293 HV.

As shown in FIG. 3, cracks of 100 μm or less were observed in the samples having the two levels of Vickers hardness, namely, 160 HV and 273 HV. In contrast, a crack of approximately 200 μm was observed in the sample having the level of 293 HV. A rate of an increase in the maximum crack length relative to an increase in the Vickers hardness from point P2 to point P3 is significantly greater than a rate of an increase in the maximum crack length relative to an increase in the Vickers hardness from point P1 to point P2. In other words, an inclination of the line connecting point P2 to point P3 is significantly steeper than an inclination of the line connecting point P1 to point P2. These results indicate that under the condition of 5% strain, which corresponds to a harsh use environment, stress corrosion cracking of the steel material 3 resulting from being in contact with liquid ammonia may be appropriately restricted when the Vickers hardness of the steel material 3 is less than or equal to 280 HV, preferably, less than or equal to 273 HV.

As described above, when the Vickers hardness of the steel material 3 is 280 HV or less, stress corrosion cracking of the steel material 3 resulting from being in contact with liquid ammonia may be restricted not only under a normal use environment but also under a harsh use environment. Accordingly, even if a portion of the container 1 is locally exposed to a harsh use environment, stress corrosion cracking of such a portion may be restricted as long as the Vickers hardness of the steel material 3 is 280 or less.

The hardness of the heat-affected zone 5 in the steel material 3 of the welded joint 2 is likely to be increased by the heat of welding. Thus, when the Vickers hardness of the heat-affected zone 5 after welding is 280 HV or less, stress corrosion cracking of the steel material 3 resulting from being in contact with liquid ammonia may be minimized.

The container 1 may have a Vickers hardness of 280 HV or less at least at the heat-affected zone 5 located near the first surface S1, which is configured to be in contact with liquid ammonia. In other words, the steel material 3 of the container 1 may have the Vickers hardness of 280 HV or less at least at the heat-affected zone 5 adjacent to the welded metal portion 6, which is located near the first surface S1 configured to be in contact with liquid ammonia. The Vickers hardness of the heat-affected zone 5 in the steel material 3 of the welded joint 2 may be measured at a depth of 2 mm from the surface of the steel material 3.

### First Embodiment of Welding Process

A first embodiment of a welding process for reducing the Vickers hardness of the heat-affected zone 5 in the steel material 3 to 280 HV or less will now be described with reference to FIG. 4.

As shown in FIG. 4, in the first embodiment of the welding process, multiple passes are performed at the side of the first surface S1 by horizontal submerged arc welding performed on the two pieces of the steel material 3 arranged in the vertical direction. That is, the welded metal portion 6 obtained by the first embodiment of the welding process includes multiple beads 6B, each formed by a welding pass.

The beads 6B are formed by welding passes sequentially performed in a welding region from a position located lowest and farthest from the first surface S1. Accordingly, a final bead 6BF formed by the final pass of the multiple passes corresponds to a bead 6B that is located at the uppermost position and is part of the first surface S1 in the welded joint 2. That is, the final bead 6BF is a bead 6B that is formed last among the beads 6B adjacent to the heat-affected zone 5.

The hardness of the heat-affected zone 5 will now be described. In the heat-affected zone 5 located below the welded metal portion 6 of the welded joint 2, the hardness is temporarily increased when the beads 6B are formed in the vicinity of the heat-affected zone 5. However, the increase in the hardness of the heat-affected zone 5 is reduced by the heat of the subsequently performed passes. On the other hand, in the heat-affected zone 5 adjacent to the final bead 6BF, the welding ends in a state in which the hardness is increased by the heat of the final bead 6BF. Thus, the heat-affected zone 5 adjacent to the final bead 6BF is a portion of the steel material 3 in the welded joint 2 where the hardness is most likely to increase.

In the first embodiment, the amount of heat applied through the final bead 6BF to the heat-affected zone 5 is adjusted so that the Vickers hardness of the heat-affected zone 5 adjacent to the final bead 6BF becomes 280 HV or less. In the first embodiment, the heat applied through the final bead 6BF to the heat-affected zone 5 refers to the heat applied to the heat-affected zone 5 by the final pass. Specifically, in the first embodiment of the welding process, the final bead 6BF is formed under conditions in which the preheat temperature is higher and the heat input is greater than those of the preceding passes prior to the final pass. This lowers the cooling rate of the heat-affected zone 5 adjacent to the final bead 6BF, thereby limiting an increase in the hardness of the heat-affected zone 5 adjacent to the final bead 6BF.

The heat input may be calculated by the following equation “Q=60×E×I/V=E×I×T×10/L”. In this equation, “Q” represents the heat input (J/cm), “E” represents the arc voltage (V), “I” represents the welding current (A), “V” represents the welding speed (cm/min), “T” represents the arc time (sec), and “L” represents the welding length (mm).

In an example, a case in which the preheat temperature of the final pass is higher than those of the preceding passes prior to the final pass may include a case in which the preheat temperature of the final pass is higher than the average preheat temperature of the preceding passes prior to the final pass. In another example, a case in which the preheat temperature of the final pass is higher than those of the preceding passes prior to the final pass may include a case in which the preheat temperature of the final pass is higher than the preheat temperature of any one of the preceding passes prior to the final pass (e.g., pass immediately preceding the final pass).

In an example, a case in which the heat input of the final pass is greater than those of the preceding passes prior to the final pass may include a case in which the heat input of the final pass is greater than the average heat input of the preceding passes prior to the final pass. In another example, a case in which the heat input of the final pass is greater than those of the preceding passes prior to the final pass may include a case in which the heat input of the final pass is greater than the heat input of any one of the preceding passes prior to the final pass (e.g., pass immediately preceding the final pass).

In an example, in the preceding passes prior to the final pass, the preheat temperature is controlled in a range of 94° C. to 150° C., inclusive, and the heat input is controlled in a range of 11.2 kJ/cm to 25.0 kJ/cm, inclusive.

In an example, in the final pass, the preheat temperature is controlled in a range of 180° C. to 250° C., inclusive; preferably, in a range of 200° C. to 230° C., inclusive; and more preferably, in a range of 210° C. to 220° C., inclusive.

In an example, in the final pass, the heat input is controlled to be less than 30.0 kJ/cm and greater than those of the preceding passes prior to the final pass. The heat input of the final pass is, for example, 29 kJ/cm or less; preferably, 28.0 kJ/cm or less; more preferably, 27 kJ/cm or less; and even more preferably, 26 kJ/cm or less. In an example, the heat input of the final pass is 25.5 kJ/cm or less. Furthermore, the heat input of the final pass is, for example, 20.0 kJ/cm or greater; preferably, 21.0 kJ/cm or greater; more preferably, 22.0 kJ/cm or greater; even more preferably, 23.0 kJ/cm or greater; and particularly preferably, 24.0 kJ/cm or greater.

In an example, in the preceding passes prior to the final pass, the heat input of several passes from the initial pass may be relatively large within the above numerical ranges so as to avoid lack of fusion, and the heat input of the subsequent passes may be relatively small within the above numerical ranges. For example, the heat input of the initial pass or several passes from the initial pass may be substantially equal to that of the final pass, and the heat input of the subsequent passes may be less than that of the final pass.

### Advantages of the First Embodiment

(1-1) With the welding process of the first embodiment, the Vickers hardness may be reduced to 280 HV or less in the heat-affected zone 5 adjacent to the welded metal portion 6, which is formed at the side of the first surface S1 of the steel material 3 configured to be in contact with liquid ammonia. As a result, even if a portion of the container 1 is locally exposed to a harsh use environment, stress corrosion cracking of this portion may be restricted.
(1-2) If the container 1 was a small-sized facility, heat treatment or the like may be performed on the entire container 1 so as to reduce the hardness increased by welding. However, in a case of an ammonia tank constructed as a large structure, it is difficult to use the same method to improve the hardness. In this respect, the welding process of the first embodiment readily reduces the Vickers hardness of the heat-affected zone 5 in an ammonia tank constructed as a large structure.
(1-3) In the first embodiment, in the final pass of the multiple passes, the final bead 6BF is formed under conditions in which the preheat temperature is higher and the heat input is greater than those of the preceding passes prior to the final pass. This lowers the cooling rate of the heat-affected zone 5 adjacent to the final bead 6BF, thereby limiting an increase in the hardness of the heat-affected zone 5 adjacent to the final bead 6BF.

If the heat input of the entire preceding passes prior to the final pass is substantially equal to that of the final pass, the welded metal portion 6 and the heat-affected zone 5 may be excessively heated at portions located near the center of the steel material 3 in the thickness-wise direction. This may adversely affect the mechanical properties, such as the toughness, of these portions. Accordingly, setting the heat input of the final pass to be greater than those of the preceding passes prior to the final pass avoids adverse effect on the mechanical properties of the portions of the welded metal portion 6 and the heat-affected zone 5 located near the thickness-wise center of the steel material 3, while limiting an increase in the hardness of the heat-affected zone 5 adjacent to the final bead 6BF.
(1-4) If horizontal welding is performed under a condition in which the heat input is excessively high, the molten metal may droop downward. In this respect, the heat input of the final pass is set to be less than 30.0 kJ/cm. This avoids drooping of molten metal even when horizontal submerged arc welding is performed.
(1-5) The final pass is performed by submerged arc welding under conditions in which the preheat temperature is higher than those of the preceding passes and the heat input is set to be 20.0 kJ/cm or greater. This limits an increase in the hardness of the heat-affected zone 5 adjacent to the final bead 6BF in a preferred manner.
(1-6) If the preheat temperature is excessively high, the welder may have to bear the physical burden of being exposed to such a higher temperature, and the preheating process may require a longer period of time. This may lower the working efficiency. In this respect, the preheat temperature of the final pass is set to 250° C. or lower, thereby maintaining the manufacturability.
(1-7) In the first embodiment, the steel material 3 in the raw material state has a tensile strength in a range of 485 MPa to 690 MPa, inclusive. When the above-described welding process is performed on such a steel material 3, stress corrosion cracking of the container 1 may be restricted in a preferred manner.

### Modified Examples of the First Embodiment

The first embodiment may be modified as follows. The first embodiment and the following modifications can be combined as long as the combined modifications remain technically consistent with each other.

In the first embodiment, as long as the Vickers hardness of the heat-affected zone 5 becomes 280 HV or less, the welding conditions of the final pass may be changed within a range in which the preheat temperature is higher and the heat input is greater than at least those of the pass immediately preceding the final pass. In other words, as long as the Vickers hardness of the heat-affected zone 5 becomes 280 HV or less, the final pass may be performed under welding conditions in which the preheat temperature and the heat input are outside the above-described numerical ranges.

### Second Embodiment of Welding Process

A second embodiment of a welding process for reducing the Vickers hardness of the heat-affected zone 5 in the steel material 3 to 280 HV or less will now be described with reference to FIG. 4. The second embodiment is the same as the first embodiment except in that the preceding passes prior to the final pass are performed by submerged arc welding and then the final pass is performed by shielded metal arc welding.

In the second embodiment, in the same manner as the first embodiment, the amount of heat applied through the final bead 6BF to the heat-affected zone 5 is adjusted so that the Vickers hardness of the heat-affected zone 5 adjacent to the final bead 6BF becomes 280 HV or less. In the second embodiment, the heat applied through the final bead 6BF to the heat-affected zone 5 refers to the heat applied to the heat-affected zone 5 by the final pass. Specifically, the final bead 6BF is formed by performing horizontal shielded metal arc welding under conditions in which the preheat temperature is higher and the heat input is greater than those of the preceding passes prior to the final pass. This lowers the cooling rate of the heat-affected zone 5 adjacent to the final bead 6BF in the same manner as the first embodiment, thereby limiting an increase in the hardness of the heat-affected zone 5 adjacent to the final bead 6BF.

The amount of heat dissipated during shielded metal arc welding is likely to be greater than that of submerged arc welding. For example, in ISO 17671-1:2002, the value “k” representing the thermal efficiency factor, which is used to calculate the heat input, is set to “1” for submerged arc welding, and “0.8” for shielded metal arc welding. In particular, in a case in which the voltage, the current, and the welding speed are the same, the effective amount of heat input during shielded metal arc welding is approximately 0.8 times the effective amount of heat input during submerged arc welding. Thus, when the final pass is performed by shielded metal arc welding, the heat input should be greater than that when the final pass is performed by submerged arc welding.

In an example, in the preceding passes prior to the final pass, the preheat temperature and the heat input are controlled in the same manner as in the first embodiment. In an example, in the final pass, in the same manner as the first embodiment, the preheat temperature is controlled in a range of 180° C. to 250° C., inclusive; preferably, in a range of 200° C. to 230° C., inclusive; and more preferably, in a range of 210° C. to 220° C., inclusive. Furthermore, for example, in the final pass, the heat input is controlled to be greater than 24.0 kJ/cm and less than or equal to 30.0 kJ/cm. It is preferred that the final pass is performed by shielded metal arc welding under a condition in which the heat input is 25.0 kJ/cm or greater.

### Advantages of the Second Embodiment

(2-1) The welding process of the second embodiment has the same advantages (1-1) to (1-3), (1-6), and (1-7) of the first embodiment. In addition, the final pass is performed by shielded metal arc welding under conditions in which the preheat temperature is higher than those of the preceding passes and the heat input is set to be greater than 24.0 kJ/cm. This limits an increase in the hardness of the heat-affected zone 5 adjacent to the final bead 6BF in a preferred manner.
(2-2) The heat input of the final pass during shielded metal arc welding is set to be 30.0 kJ/cm or less. This avoids drooping of the molten metal even when the horizontal shielded metal arc welding is performed.

### Modified Example of the Second Embodiment

The second embodiment may be modified as follows. The second embodiment and the following modifications can be combined as long as the combined modifications remain technically consistent with each other.

In the second embodiment, as long as the Vickers hardness of the heat-affected zone 5 becomes 280 HV or less, the welding conditions of the final pass may be changed within a range in which the preheat temperature is higher and the effective heat input is greater than at least those of the pass immediately preceding the final pass. In other words, as long as the Vickers hardness of the heat-affected zone 5 becomes 280 HV or less, the final pass may be performed under welding conditions in which the preheat temperature and the heat input are outside the above-described numerical ranges.

### Third Embodiment of Welding Process

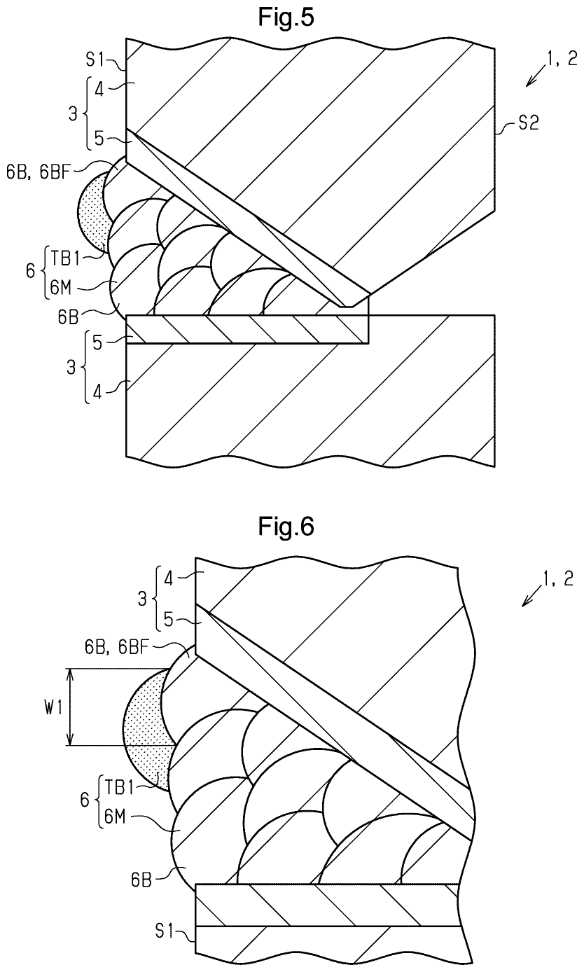

A third embodiment of a welding process for reducing the Vickers hardness of the heat-affected zone 5 in the steel material 3 to 280 HV or less will now be described with reference to FIGS. 5 and 6.

As shown in FIG. 5, the welded metal portion 6 formed in accordance with the third embodiment of the welding process includes a main welded metal portion 6M and a temper bead portion TB1. The main welded metal portion 6M and the temper bead portion TB1 are both formed by submerged arc welding. In FIGS. 5 and 6, the main welded metal portion 6M is hatched, and the temper bead portion TB1 is dotted.

The main welded metal portion 6M is formed by multiple passes. In other words, the main welded metal portion 6M includes multiple beads 6B. The passes of the main welded metal portion 6M may be performed under the same conditions of the preheat temperature and the heat input under which the preceding passes prior to the final pass are performed in the first and second embodiments.

The temper bead portion TB1 is formed by a single pass performed after the main welded metal portion 6M has been formed. That is, the temper bead portion TB is formed by a single bead. The temper bead portion TB1 is overlaid on the final bead 6BF, which is formed by the final pass of the multiple passes forming the main welded metal portion 6M, and not overlaid on the steel material 3. That is, also in the third embodiment, the final bead 6BF is a bead 6B that is formed last among the beads 6B adjacent to the heat-affected zone 5. The pass of the temper bead portion TB1 may be performed under the same conditions of the preheat temperature and the heat input under which the preceding passes prior to the final pass are performed in the first and second embodiments.

In the third embodiment, in the same manner as the other embodiments, the amount of heat applied through the final bead 6BF to the heat-affected zone 5 is adjusted so that the Vickers hardness of the heat-affected zone 5 adjacent to the final bead 6BF becomes 280 HV or less. In the third embodiment, the heat applied through the final bead 6BF to the heat-affected zone 5 refers to both the heat applied to the heat-affected zone 5 by the pass of the temper bead portion TB1, and the heat applied to the heat-affected zone 5 by the final pass. Specifically, in the third embodiment, unlike the first and second embodiments, the main welded metal portion 6M is formed without significantly changing the preheat temperature and the heat input of the final pass from those of the preceding passes prior to the final pass. Then, the temper bead portion TB1 is overlaid on the final bead 6BF, so that the heat of forming the temper bead portion TB1 is transferred through the final bead 6BF to the heat-affected zone 5 adjacent to the final bead 6BF. This provides an annealing effect on the heat-affected zone 5 adjacent to the final bead 6BF, which has been hardened by the heat of the final pass of the main welded metal portion 6M. As a result, the hardness of the heat-affected zone 5 adjacent to the final bead 6BF is reduced.

If the temper bead portion TB1 is overlaid on the steel material 3, the heat-affected zone 5 adjacent to the final bead 6BF may be excessively heated. In this case, the heat-affected zone 5 adjacent to the final bead 6BF may become hardened again, for example, when the γ-phase changes to martensite, bainite, or both of these, during cooling. In this respect, the temper bead portion TB1 is arranged to not overlap the steel material 3. This avoids excess heating of the heat-affected zone 5 adjacent to the final bead 6BF, thereby reducing the hardness thereof in a preferred manner.

As shown in FIG. 6, in a cross-sectional view taken in the welding direction, it is preferred that an overlap width W1 of the temper bead portion TB1 and the final bead 6BF be ½ or greater and ⅔ or less of the width of the final bead 6BF. With such an overlap width W1, the heat-affected zone 5 adjacent to the final bead 6BF will not be heated excessively, and the heat-affected zone 5 will be appropriately softened by an annealing effect.

### Advantages of the Third Embodiment

(3-1) The welding process of the third embodiment obtains the same advantages (1-1), (1-2), and (1-7) of the first embodiment. Further, in the third embodiment, the temper bead portion TB1 is overlaid on the final bead 6BF after the main welded metal portion 6M has been formed, so that the heat of forming the temper bead portion TB1 is transferred through the final bead 6BF to the heat-affected zone 5. This provides an annealing effect on the heat-affected zone 5 adjacent to the final bead 6BF, thereby reducing the hardness of the heat-affected zone 5, which has been hardened by the heat of the final pass of the main welded metal portion 6M.
(3-2) The overlap width W1 is set to be ½ or greater and ⅔ or less of the width of the final bead 6BF. This avoids excess heating of the heat-affected zone 5 adjacent to the final bead 6BF, and appropriately softens the heat-affected zone 5.

### Modified Examples of the Third Embodiment

The third embodiment may be modified as follows. The third embodiment and the following modifications can be combined as long as the combined modifications remain technically consistent with each other.

In the third embodiment, the welded metal portion 6 may include a plurality of temper bead portions TB1.

In the third embodiment, as long as the Vickers hardness of the heat-affected zone 5 becomes 280 HV or less, the overlap width W1 is not limited to ½ or greater and ⅔ or less of the width of the final bead 6BF, and may be less than ½ or greater than ⅔ of the width of the final bead 6BF.

In the third embodiment, after the main welded metal portion 6M is formed, approximately one-half of the final bead 6BF may be shaved off in a thickness-wise direction. Then, the temper bead portion TB1 may be overlaid on the shaved final bead 6BF. This allows the annealing effect to reach deeper portions of the heat-affected zone 5. In the third embodiment, after the main welded metal portion 6M is formed, the temper bead portion TB1 may be overlaid on the final bead 6BF without performing any processing, such as machining, on the final bead 6BF.

### Modified Examples of the First to Third Embodiments

The first to third embodiments may be modified as follows. The first to third embodiments and the following modifications can be combined as long as the combined modifications remain technically consistent with each other.

The welding process in accordance with the first to third embodiments may be applied to overlay welding or the like that is performed to repair the container 1, in addition to manufacturing of the welded joint 2 that connects two pieces of the steel material 3.

The container 1 does not have to be cylindrical, and may be spherical. The container 1 is not limited to an on-ground low-temperature ammonia tank, and may be an ammonia tank constructed as a structure of a vessel or the like. Alternatively, the container 1 is not limited to an ammonia tank constructed as a large-sized structure, and may be an ammonia tank constructed as a small-sized facility, for example, configured to be installed indoors.

### Experimental Examples

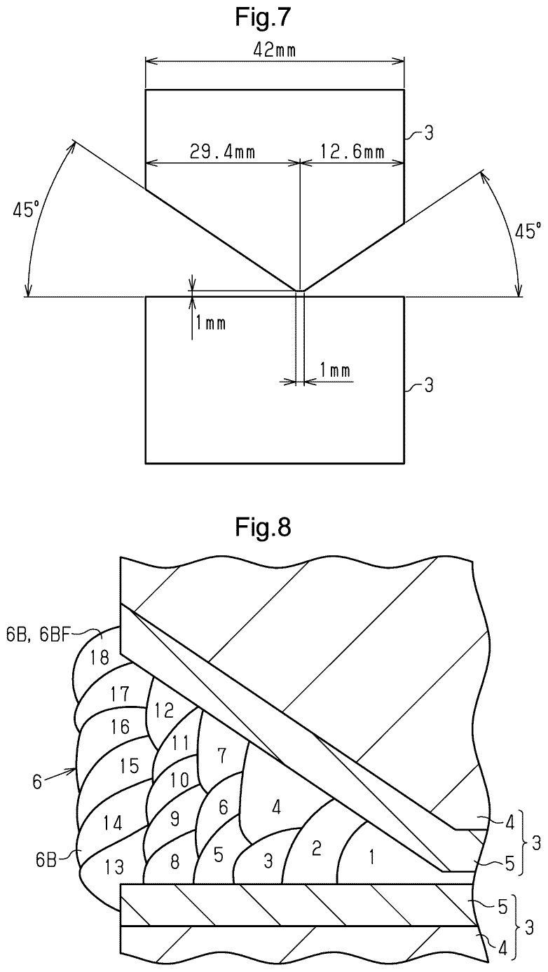

Experimental examples will now be described with reference to FIGS. 7 to 26. The conditions of the experimental examples are merely examples or comparative examples of the first to third embodiments, and are not intended to limit the above-described embodiments.

### Experimental Example 1

In Experimental Example 1, in the same manner as the first embodiment, multiple passes were formed by horizontal submerged arc welding performed on two pieces of vertically arranged steel material 3 to produce the welded joint 2.

The material (ASTM A516Gr70N) obtained by normalizing carbon steel in accordance with ASTM A516Gr70 was used as the steel material 3. The tensile strength of the steel material 3 in the raw material state was 76 KSI or greater and 79 KSI or less (approximately 524 MPa or greater and approximately 545 MPa or less). The steel material 3 was shaped as shown in FIG. 7. The groove was K-shaped.

In Experimental Example 1 and other experimental examples, which will be described later, “first welding” refers to the welding performed at left side of the K-shaped groove as viewed in FIG. 7, and “second welding” refers to the welding performed at the right side of the K-shaped groove as viewed in FIG. 7. The welding conditions were changed between the first welding and the second welding. Specifically, the first welding, gouging, and the second welding were performed in this order.

Welding conditions common in the first and second welding of Experimental Example 1 (hereafter, “common conditions”) will now be described. The welding method was horizontal submerged arc welding. The welding material was the welding wire “US-36” having a diameter of 3.2 mm (manufactured by Kobe Steel, Ltd.). The flux was “MF-33H” (manufactured by Kobe Steel, Ltd.). The polarity of the electrode was direct current electrode positive (DCEP). The current was 420 A or greater and 510 A or less. The voltage was 23 V or greater and 32 V or less. The welding speed was 30 cm/sec or greater and 70 cm/sec or less. In Experimental Example 1, the heat input was increased mainly by lowering the welding speed within the above numerical range.

As shown in FIG. 8, the first welding of Experimental Example 1 formed the welded metal portion 6 including eighteen beads 6B formed by eighteen passes. In FIG. 8, the numerals indicated on the bead 6B represent the sequence in which the passes of the beads 6B were performed.

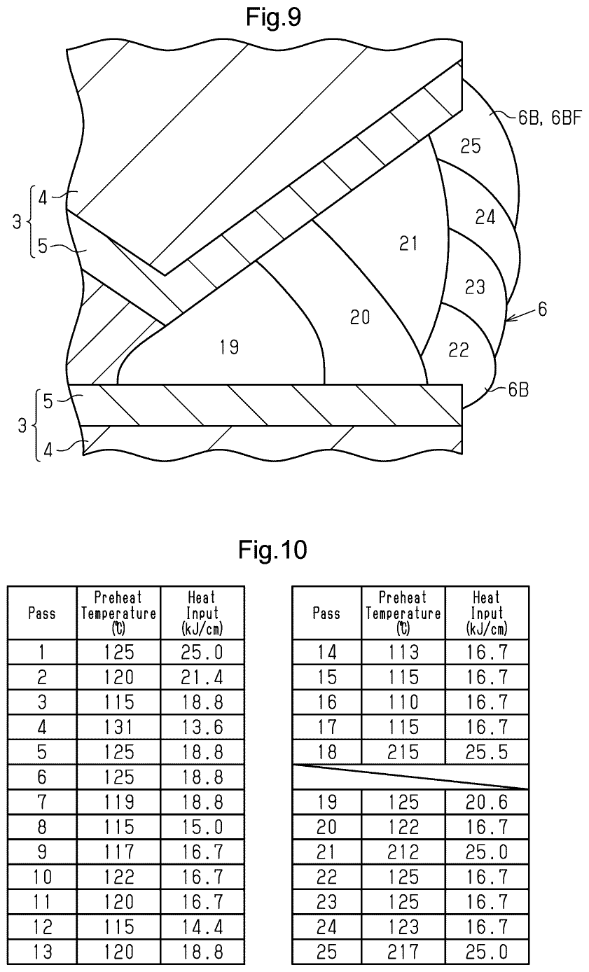

As shown in FIG. 9, the second welding of Experimental Example 1 formed the welded metal portion 6 including seven beads 6B formed by seven passes. In FIG. 9, the numerals indicated on the bead 6B represent the sequence in which the passes of the beads 6B were performed. The numerals are consecutively continued from the first welding. More specifically, the pass numbered “19” is the first pass in the second welding of Experimental Example 1. Further, the pass numbered “25” is the seventh pass that is the final pass in the second welding of Experimental Example 1.

FIG. 10 shows the preheat temperature and the heat input of each pass of Experimental Example 1.

As shown in FIG. 10, in the final pass in the first welding of Experimental Example 1, the final bead 6BF was formed under conditions in which the preheat temperature was higher and the heat input was greater than those of the preceding passes prior to the final pass. In the first pass of the first welding of Experimental Example 1, the heat input was as large as that of the final pass. In the first to seventeenth passes of the first welding, the average of the preheat temperature was approximately 119° C., and the average of the heat input was approximately 17.7 kJ/cm.

In the final pass in the second welding of Experimental Example 1, the final bead 6BF was formed under conditions in which the preheat temperature was higher and the heat input was greater than those of the preceding passes prior to the final pass. In the second welding of Experimental Example 1, the pass numbered “21” was formed under conditions in which the preheat temperature and the heat input were set to be substantially equal to those of the final pass. The pass “21” is located one layer inward from the final pass. In the first to sixth passes (passes “19” to “24”) of the second welding, the average of the preheat temperature was approximately 139° C., and the average of the heat input was approximately 18.7 kJ/cm.

The Vickers hardness of the welded joint 2, produced as described above, was measured in accordance with JIS Z 2244-1:2024 at both sides where the first welding and the second welding were performed. The Vickers hardness was measured at a position exposed by cutting the surface of the steel material 3 by 2 mm in the depth-wise direction (thickness-wise direction). The distance between measurement points was 1 mm in the base metal 4 and the welded metal portion 6, and 0.5 mm in the heat-affected zone 5. The test force was 98.07 N.

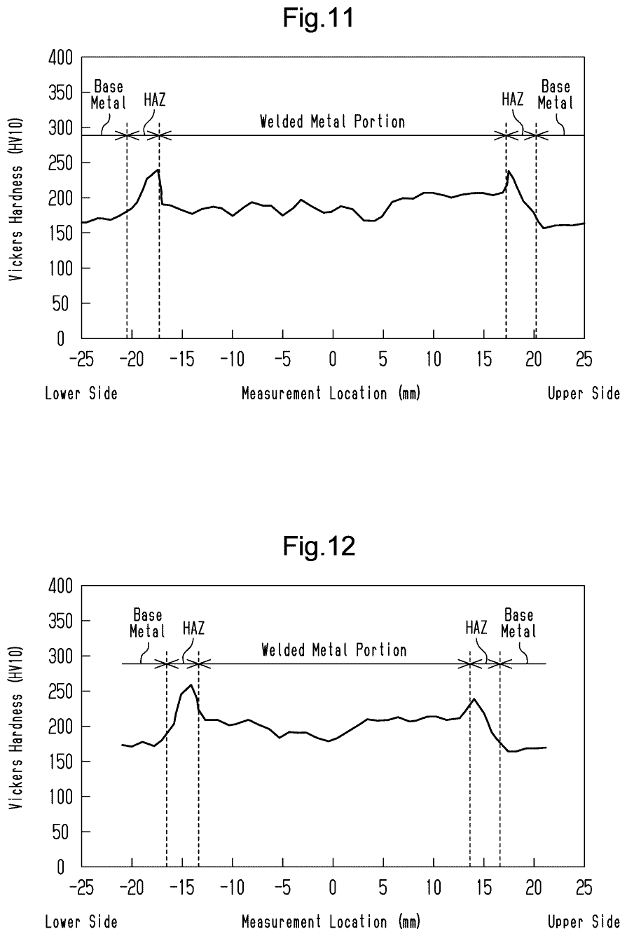

FIG. 11 shows the Vickers hardness in the welded joint 2 of Experimental Example 1 at the side where the first welding was performed. In FIG. 11, the upper side of the welded joint 2 corresponds to the side (positive side) toward which the values on the horizontal axis indicating the measurement locations increase. Accordingly, in FIG. 11, the heat-affected zone 5 adjacent to the final bead 6BF formed by the final pass is located at the right side of the region corresponding to the welded metal portion 6.

As shown in FIG. 11, at the side of the steel material 3 where the first welding was performed, the hardness of the heat-affected zone 5 increased to be greater than that of the base metal 4. Nonetheless, the Vickers hardness remained lower than or equal to 280 HV in both the heat-affected zone 5 adjacent to the final bead 6BF formed by the final pass, and the heat-affected zone 5 located at the opposite side. Specifically, the hardness of the heat-affected zone 5 adjacent to the final bead 6BF formed by the final pass was 240 HV.

FIG. 12 shows the Vickers hardness in the welded joint 2 of Experimental Example 1 at the side where the second welding was performed. As shown in FIG. 12, at the side of the steel material 3 where the second welding was performed, the hardness of the heat-affected zone 5 increased to be greater than that of the base metal 4. Nonetheless, in the same manner as the first welding, the Vickers hardness remained lower than or equal to 280 HV in both the heat-affected zone 5 adjacent to the final bead 6BF formed by the final pass, and the heat-affected zone 5 located at the opposite side. Specifically, the hardness of the heat-affected zone 5 adjacent to the final bead 6BF formed by the final pass was 235 HV.

The above results indicate that the hardness of the heat-affected zone 5 adjacent to the final bead 6BF may be reduced to 280 HV or less by increasing the preheat temperature and the heat input of the final pass to be greater than those of the preceding passes prior to the final pass. Further, the results of the first and second welding indicate that the hardness of the heat-affected zone 5 adjacent to the final bead 6BF may be reduced to 280 HV or less by at least increasing the preheat temperature and the heat input of the final pass without increasing those of the passes of the beads 6B adjacent to the final bead 6BF.

### Experimental Example 2

In Experimental Example 2, in the same manner as the second embodiment, multiple passes were formed by horizontal submerged arc welding performed on two pieces of vertically arranged steel material 3, and then the final pass was performed by shielded metal arc welding to produce the welded joint 2.

In Experimental Example 2, the steel material 3 had substantially the same properties and shape as those of Experimental Example 1. Further, in Experimental Example 2, the passes, except for the final pass, were performed by submerged arc welding under welding conditions that are the same as the common conditions of Experimental Example 1. In shielded metal arc welding performed in the final pass, the welding material was the welding bar “LB-52NS” having a diameter of 4.2 mm (manufactured by Kobe Steel, Ltd.). The polarity of the electrode was direct current electrode positive (DCEP). The current was 160 A. The voltage was 25 V.

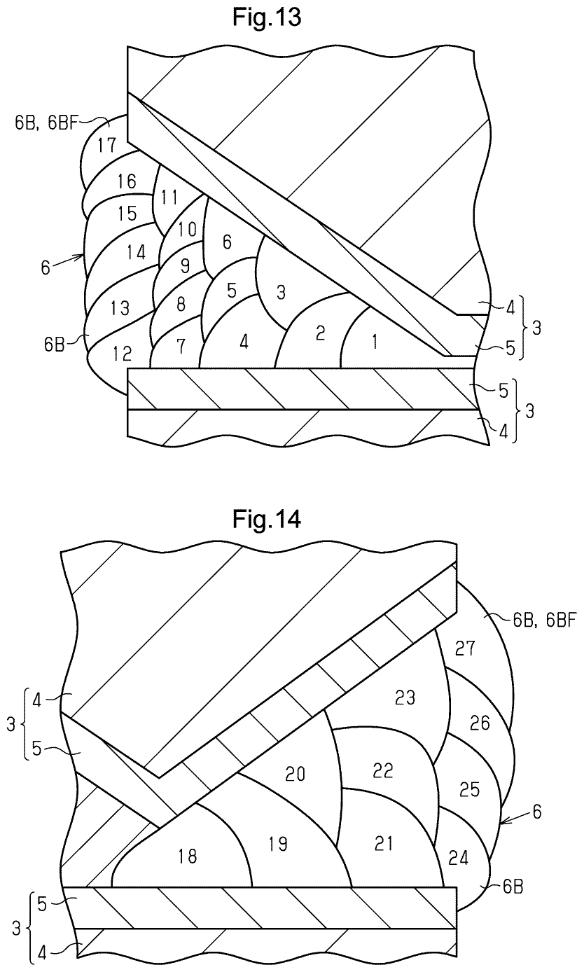

As shown in FIG. 13, the first welding of Experimental Example 2 formed the welded metal portion 6 including seventeen beads 6B formed by seventeen passes. The first to sixteenth passes in the first welding of Experimental Example 2 were performed by submerged arc welding. The seventeenth pass, which is the final pass in the first weld of Experimental Example 2, was performed by shielded metal arc welding.

As shown in FIG. 14, the second welding of Experimental Example 2 formed the welded metal portion 6 including ten beads 6B formed by ten passes. The first to ninth passes (numbered “18” to “26”) in the second welding of Experimental Example 2 were performed by submerged arc welding. The tenth pass (numbered “27”), which is the final pass in the second weld of Experimental Example 2, was performed by shielded metal arc welding.

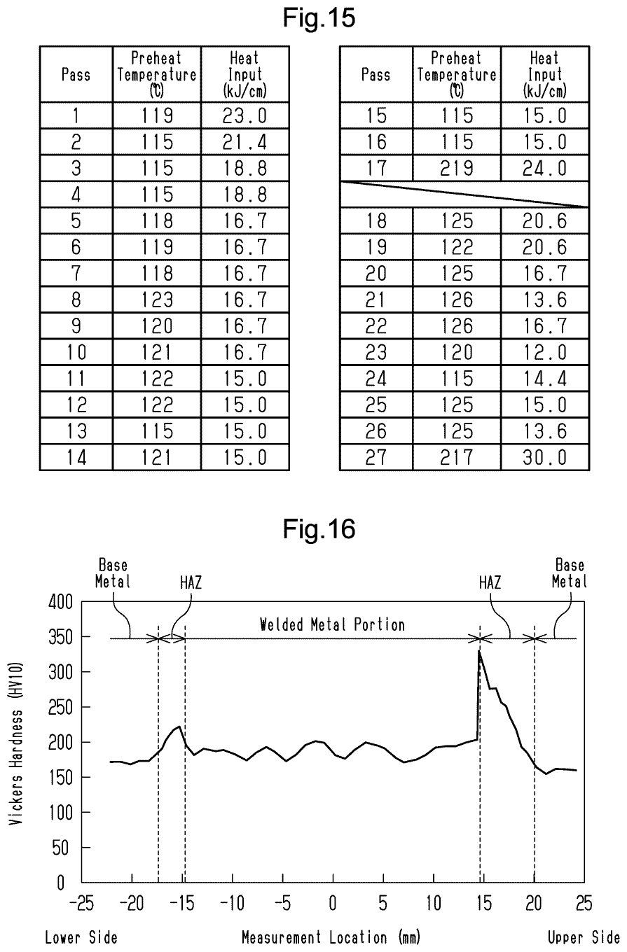

FIG. 15 shows the preheat temperature and the heat input of each pass of Experimental Example 2.

As shown in FIG. 15, in the final pass of the first welding of Experimental Example 2, the preheat temperature was set to 219° C., and the heat input was set to 24.0 kJ/cm. In the first to sixteenth passes of the first welding of Experimental Example 2, the average value of the preheat temperature was approximately 118° C., and the average value of the heat input was approximately 17.0 kJ/cm.

In the final pass of the second welding of Experimental Example 2, the preheat temperature was set to 217° C., and the heat input was set to 30.0 kJ/cm. In the first to ninth passes (numbered “18” to “26”) of the second welding of Experimental Example 2, the average value of the preheat temperature was approximately 123° C., and the average value of the heat input was approximately 15.9 kJ/cm. In the final pass of the second welding of Experimental Example 2, the heat input was increased to be greater than that of the first welding by decreasing the welding speed to be lower than that of the first welding.

The Vickers hardness of the welded joint 2, produced as described above, was measured in the same manner as Experimental Example 1.

FIG. 16 shows the Vickers hardness in the welded joint 2 of Experimental Example 2 at the side where the first welding was performed. As shown in FIG. 16, at the side of the steel material 3 where the first welding was performed, the hardness of the heat-affected zone 5 increased to be greater than that of the base metal 4. In the heat-affected zone 5 located at the side opposite to the heat-affected zone 5 adjacent to the final bead 6BF formed by the final pass, the Vickers hardness was less than or equal to 280 HV. In contrast, in the heat-affected zone 5 adjacent to the final bead 6BF formed by the final pass, the Vickers hardness was greater than 280 HV. Specifically, the hardness of the heat-affected zone 5 adjacent to the final bead 6BF formed by the final pass was 327 HV.

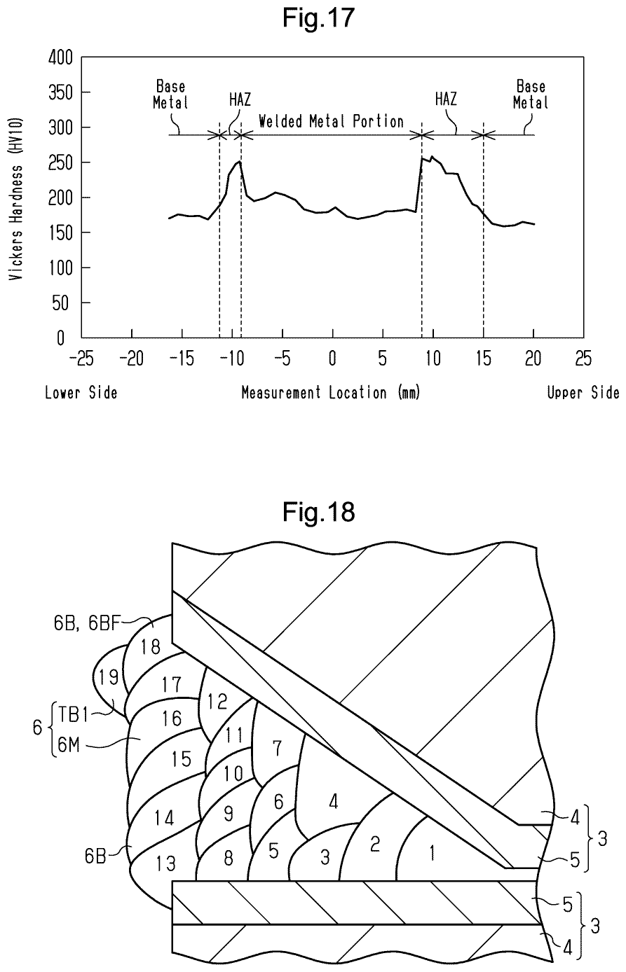

FIG. 17 shows the Vickers hardness in the welded joint 2 of Experimental Example 2 at the side where the second welding was performed. As shown in FIG. 17, at the side of the steel material 3 where the second welding was performed, the hardness of the heat-affected zone 5 increased to be greater than that of the base metal 4. Nonetheless, the Vickers hardness remained lower than or equal to 280 HV in both the heat-affected zone 5 adjacent to the final bead 6BF formed by the final pass, and the heat-affected zone 5 located at the opposite side. Specifically, the hardness of the heat-affected zone 5 adjacent to the final bead 6BF formed by the final pass was 256 HV.

The above results indicate that when the final pass is performed under conditions in which the preheat temperature is 219° C. and the heat input is 24.0 kJ/cm, the hardness of the heat-affected zone 5 adjacent to the final bead 6BF formed by the final pass becomes greater than 280 HV. On the other hand, when the final pass is performed under conditions in which the preheat temperature is 217° C. and the heat input is 30.0 kJ/cm, the hardness of the heat-affected zone 5 adjacent to the final bead 6BF formed by the final pass is reduced to 280 HV or less.

Thus, in a case in which the final pass is performed by shielded metal arc welding, an increase in the hardness of the heat-affected zone 5 adjacent to the final bead 6BF formed by the final pass may be appropriately limited by setting the heat input of the final pass to be greater than 24.0 kJ/cm. That is, even when the final pass is performed by shielded metal arc welding, the hardness of the heat-affected zone 5 adjacent to the final bead 6BF may be reduced to 280 HV or less by setting an appropriate preheat temperature and an appropriate heat input.

It can be understood that even in a case in which the final pass is performed by shielded metal arc welding under a condition in which the heat input is less than or equal to 24.0 kJ/cm, the hardness of the heat-affected zone 5 adjacent to the final bead 6BF formed by the final pass may be reduced to 280 HV or less by further increasing the preheat temperature or by restricting heat dissipation during the welding.

In ISO 17671-1:2002, the thermal efficiency factor (k) is set such that the effective heat input of shielded metal arc welding is approximately 0.8 times the effective heat input of submerged arc welding. Based on the above, it can be understood that in a case in which the final pass is performed by submerged arc welding, an increase in the hardness of the heat-affected zone 5 adjacent to the final bead 6BF formed by the final pass may be minimized by setting the heat input of the final pass to be greater than 19.2 kJ/cm, for example, 20.0 kJ/cm.

### Experimental Example 3

In Experimental Example 3, in the same manner as the third embodiment, the welded metal portion 6, which includes the main welded metal portion 6M and the temper bead portion TB1, was formed by horizontal submerged arc welding performed on two pieces of vertically arranged steel material 3 to produce the welded joint 2.

In Experimental Example 3, the steel material 3 had substantially the same properties and shape as those of Experimental Example 1. Further, in Experimental Example 3, the multiple passes of the main welded metal portion 6M and the pass of the temper bead portion TB1 were performed by submerged arc under welding conditions that are the same as the common conditions of Experimental Example 1.

As shown in FIG. 18, the first welding of Experimental Example 3 formed the welded metal portion 6, which includes the main welded metal portion 6M and the temper bead portion TB1, by nineteen passes. First, the main welded metal portion 6M including eighteen beads 6B was formed by eighteen passes. Then, the temper bead portion TB1 was formed by a single pass.

The temper bead portion TB1 was formed so that the overlap width W1 of the temper bead portion TB1 relative to the final bead 6BF formed by the eighteenth pass, which is the final pass of the main welded metal portion 6M, is ½ or greater and ⅔ or less of the width of the final bead 6BF.

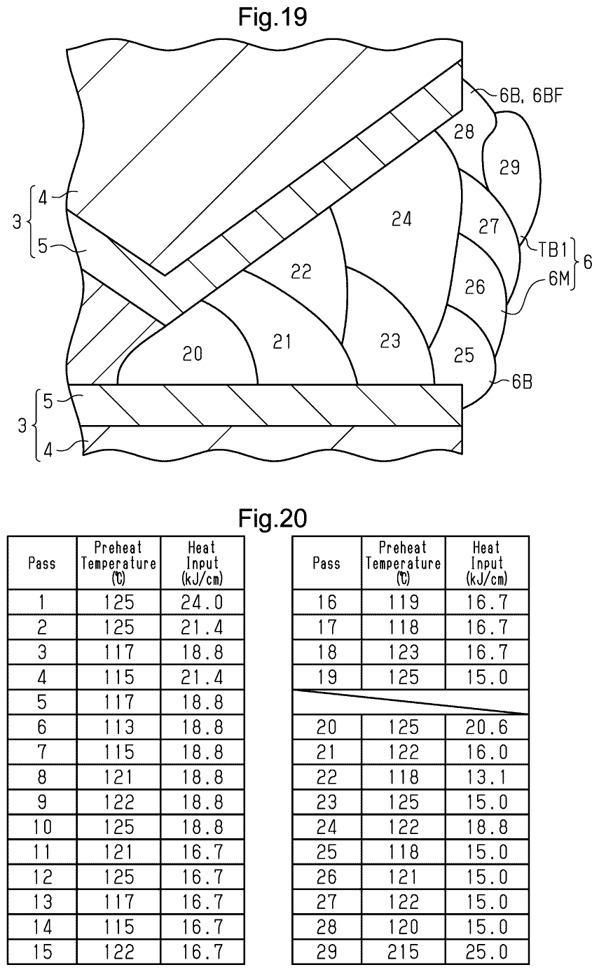

As shown in FIG. 19, the second welding of Experimental Example 3 formed the welded metal portion 6 including the main welded metal portion 6M and the temper bead portion TB1 by ten passes. First, the main welded metal portion 6M including eighteen beads 6B was formed by nine passes. Then the temper bead portion TB1 was formed by a single pass.

After the main welded metal portion 6M was formed by the nine passes in the second welding of Experimental Example 3, the final bead 6BF formed by the ninth pass (numbered “28”), which is the final pass of the main welded metal portion 6M, was cut by approximately one-half in the depth-wise direction (thickness-wise direction). Then, the temper bead portion TB1 was overlaid on the cut final bead 6BF, such that the overlap width W1 is ½ or greater and ⅔ or less of the width of the final bead 6BF.

FIG. 20 shows the preheat temperature and the heat input of each pass of Experimental Example 3.

As shown in FIG. 20, in the first welding of Experimental Example 3, the preheat temperature and the heat input of the eighteenth pass, which is the final pass of the main welded metal portion 6M, were set to be substantially equal to those of the preceding passes (for example, the immediately preceding pass). In the nineteenth pass for forming the temper bead portion TB1, the preheat temperature and the heat input were set to be substantially equal to those of the eighteenth pass (preheat temperature: 125° C., heat input: 15.0 kJ/cm).

In the second welding of Experimental Example 3, the preheat temperature and the heat input of the ninth pass (numbered “28”), which is the final pass of the main welded metal portion 6M, were set to be substantially equal to those of the preceding passes (for example, the immediately preceding pass). In the tenth pass (numbered “29”) for forming the temper bead portion TB1, the preheat temperature and the heat input were set to substantially equal to those of the final pass in Experimental Example 1 (preheat temperature: 215° C., heat input: 25.0 kJ/cm).

The Vickers hardness of the welded joint 2, produced as described above, was measured in the same manner as Experimental Example 1.

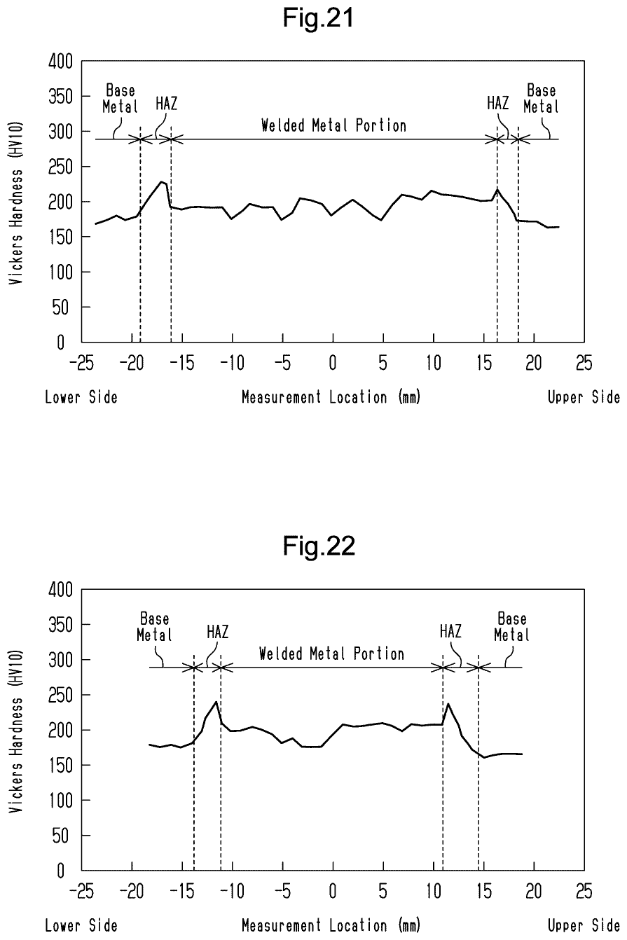

FIG. 21 shows the Vickers hardness in the welded joint 2 of Experimental Example 3 at the side where the first welding was performed. As shown in FIG. 21, at the side of the steel material 3 where the first welding was performed, the hardness of the heat-affected zone 5 increased to be greater than that of the base metal 4. Nonetheless, the Vickers hardness remained lower than or equal to 280 HV in both the heat-affected zone 5 adjacent to the final bead 6BF formed by the final pass, and the heat-affected zone 5 located at the opposite side. Specifically, the hardness of the heat-affected zone 5 adjacent to the final bead 6BF formed by the final pass was 213 HV.

FIG. 22 shows the Vickers hardness in the welded joint 2 of Experimental Example 3 at the side where the second welding was performed. As shown in FIG. 22, at the side of the steel material 3 where the second welding was performed, the hardness of the heat-affected zone 5 increased to be greater than that of the base metal 4. Nonetheless, in the same manner as the first welding, the Vickers hardness remained lower than or equal to 280 HV in both the heat-affected zone 5 adjacent to the final bead 6BF formed by the final pass, and the heat-affected zone 5 located at the opposite side. Specifically, the hardness of the heat-affected zone 5 adjacent to the final bead 6BF formed by the final pass was 234 HV.

The above results indicate that the hardness of the heat-affected zone 5 adjacent to the final bead 6BF formed by the final pass may be reduced to 280 HV or less by overlaying the temper bead portion TB1 on the final bead 6BF formed by the final pass of the main welded metal portion 6M after the main welded metal portion 6M has been formed. Also, the result of the first welding of Experimental Example 3 indicates that even when the temper bead portion TB1 is overlaid on the final bead 6BF without performing any processing, such as machining, on the final bead 6BF, the hardness of the heat-affected zone 5 adjacent to the final bead 6BF formed by the final pass may be reduced. In addition, the result of the first welding of Experimental Example 3 indicates that the hardness of the heat-affected zone 5 adjacent to the final bead 6BF formed by the final pass may be reduced without increasing the preheat temperature or the heat input of the pass of the temper bead portion TB1 to be greater than those of the other passes.

### Experimental Example 4

In Experimental Example 4, multiple passes were formed by horizontal submerged arc welding performed on two pieces of vertically arranged steel material 3 to produce the welded joint 2. In Experimental Example 4, the welded joint 2 was produced without increasing the preheat temperature and the heat input of the final pass as in Experimental Example 1, or forming the temper bead portion TB1 as in Experimental Example 3.

In Experimental Example 4, the steel material 3 had substantially the same properties and shape as those of Experimental Example 1. In Experimental Example 4, only the second welding was performed on the K-shaped groove at the right side as shown in FIG. 7. In Experimental Example 4, the welding conditions of submerged arc welding were the same as the common conditions of Experimental Example 1.

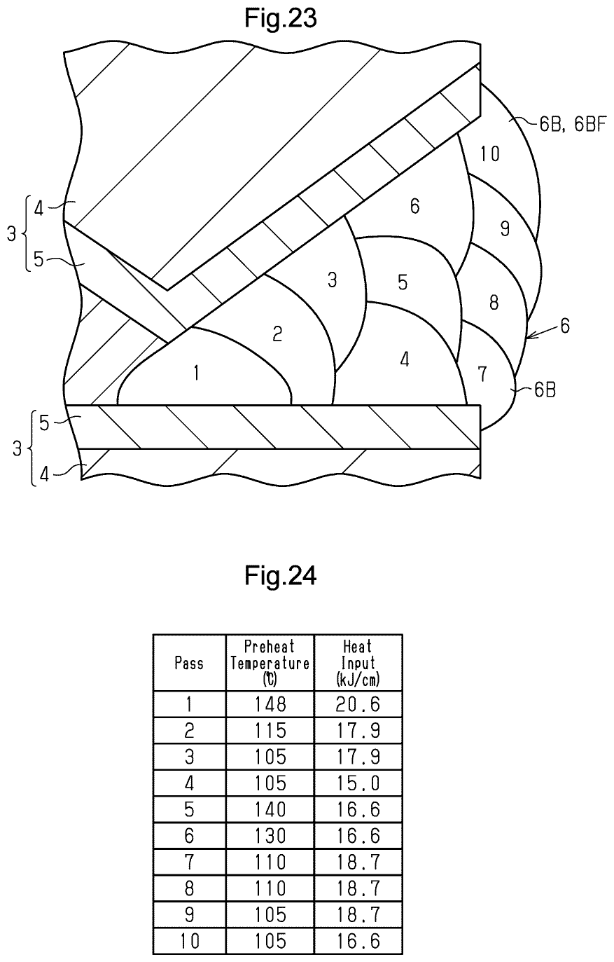

As shown in FIG. 23, in Experimental Example 4, the welded metal portion 6 including ten beads 6B was formed by ten passes.

FIG. 24 shows the preheat temperature and the heat input of each pass of Experimental Example 4. As shown in FIG. 24, in Experimental Example 4, the preheat temperature and the heat input of the tenth pass, which is the final pass of the welded metal portion 6, were set to be substantially equal to those of the preceding passes (for example, the immediately preceding pass).

The Vickers hardness of the welded joint 2, produced as described above, was measured in the same manner as Experimental Example 1.

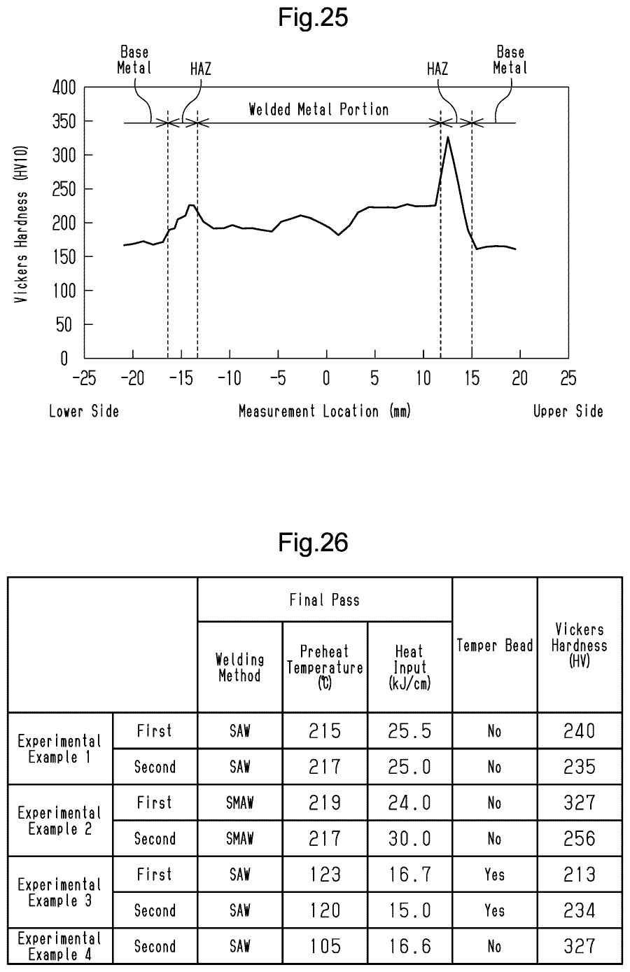

FIG. 25 shows the Vickers hardness in the welded joint 2 of Experimental Example 4 at the side where the second welding was performed. As shown in FIG. 25, the hardness of the heat-affected zone 5 in the steel material 3 of Experimental Example 4 increased to be greater than that of the base metal 4. In the heat-affected zone 5 located at the side opposite to the heat-affected zone 5 adjacent to the final bead 6BF formed by the final pass, the Vickers hardness was less than or equal to 280 HV. In contrast, in the heat-affected zone 5 adjacent to the final bead 6BF formed by the final pass, the Vickers hardness was greater than 280 HV. Specifically, the hardness of the heat-affected zone 5 adjacent to the final bead 6BF formed by the final pass was 327 HV.

The test results are summarized below.

FIG. 26 is a table showing the test results of Experimental Examples 1 to 4. In FIG. 26, the final pass of Experimental Example 3 refers to the pass immediately preceding the pass that forms the temper bead portion TB1. Further, in FIG. 26, the values indicated under “Vickers Hardness” represent the Vickers hardness of the heat-affected zone 5 adjacent to the final bead 6BF formed by the final pass.

Comparing Experimental Examples 1 and 4, the Vickers hardness of the heat-affected zone 5 adjacent to the final bead 6BF formed by the final pass may be reduced in a preferred manner when the final pass is performed by submerged arc welding under conditions in which the preheat temperature of the final pass is relatively high and the heat input of the final pass is relatively large. Comparing Experimental Examples 2 and 4, the hardness of the heat-affected zone 5 adjacent to the final bead 6BF formed by the final pass may be reduced in a preferred manner when the final pass is performed by shielded metal arc welding under conditions in which the preheat temperature and the heat input of the final pass are set to appropriate values. Comparing Experimental Examples 3 and 4, the hardness of the heat-affected zone 5 adjacent to the final bead 6BF formed by the final pass may be reduced in a preferred manner when the temper bead portion TB1 is formed.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A welding process related to a steel material of a container for liquid ammonia, the process comprising:
forming a welded metal portion at a side of the steel material, the side being configured to be in contact with the liquid ammonia, wherein
in the forming the welded metal portion, a heat-affected zone is formed in the steel material at a position adjacent to the welded metal portion,
the steel material is made of carbon steel or low-alloy steel, and
the welded metal portion is formed so that a Vickers hardness of the heat-affected zone becomes 280 HV or less.

2. The welding process according to claim 1, wherein
the welded metal portion includes multiple beads,
one of the multiple beads that is formed last is a final bead, and
the forming the welded metal portion includes adjusting an amount of heat applied through the final bead to the heat-affected zone adjacent to the final bead, so that the Vickers hardness of the heat-affected zone adjacent to the final bead becomes 280 HV or less.

3. The welding process according to claim 2, wherein
the forming the welded metal portion includes performing multiple passes to form the welded metal portion, and
in a final pass of the multiple passes, the final bead is formed under conditions in which a preheat temperature is higher and a heat input is greater than those of preceding passes of the multiple passes prior to the final pass, so that the Vickers hardness of the heat-affected zone adjacent to the final bead becomes 280 HV or less.

4. The welding process according to claim 3, wherein
the multiple passes are each performed by horizontal submerged arc welding, and
the heat input of the final pass is less than 30.0 kJ/cm.

5. The welding process according to claim 4, wherein the heat input of the final pass is 20.0 kJ/cm or greater.

6. The welding process according to claim 3, wherein
the preceding passes of the multiple passes prior to the final pass are each performed by horizontal submerged arc welding,
the final pass is performed by horizontal shielded metal arc welding, and
the heat input of the final pass is 30 kJ/cm or less.

7. The welding process according to claim 6, wherein the heat input of the final pass is greater than 24 kJ/cm.

8. The welding process according to claim 2, wherein
the welded metal portion includes a main welded metal portion and a temper bead portion, and
the forming the welded metal portion includes forming the main welded metal portion by performing multiple passes and then forming the temper bead portion, the temper bead portion being overlaid on the final bead formed by a final pass of the multiple passes and not being overlaid on the steel material, so that the Vickers hardness of the heat-affected zone adjacent to the final bead becomes 280 HV or less.

9. The welding process according to claim 8, wherein the forming the welded meatal portion includes forming the temper bead portion so that, in a cross-sectional view taken in a welding direction, an overlap width over which the temper bead portion overlaps the final bead is ½ or greater and ⅔ or less of a width of the final bead.

10. The welding process according to claim 1, wherein the container includes an ammonia tank constructed as a structure configured to hold the liquid ammonia.

11. The welding process according to claim 1, wherein the steel material is made of carbon steel.

12. The welding process according to claim 11, wherein the steel material has a tensile strength in a range of 485 MPa to 690 MPa, inclusive.

13. A container for liquid ammonia, the container comprising:
a steel material made of carbon steel or low-alloy steel; and
a welded metal portion located on a side of the steel material, the side being configured to be in contact with the liquid ammonia, wherein
the steel material includes a heat-affected zone formed at a position adjacent to the welded metal portion, and
the heat-affected zone has a Vickers hardness of 280 HV or less.

14. A method for manufacturing a container for liquid ammonia, the method comprising:
forming a welded metal portion at a side of a steel material of the container, the side being configured to be in contact with the liquid ammonia, the steel material being made of carbon steel or low-alloy steel, wherein
in the forming the welded metal portion, a heat-affected zone is formed in the steel material at a position adjacent to the welded metal portion,
the welded metal portion is formed so that a Vickers hardness of the heat-affected zone becomes 280 HV or less.
